(19) United States
(12) Patent Application Publication
(10) Pub. No.: US 2007/0035570 A1
(43) Pub. Date: Feb. 15, 2007

(54) Recording apparatus, method of transporting recording medium, and liquid ejecting apparatus

(75) Inventors: Hiroyuki Sugimoto, Nagano (JP); Katsumi Okuhara, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/498,496

(22) Filed: Aug. 2, 2006

(30) Foreign Application Priority Data
Aug. 2, 2005 (JP) 2005-223719
Jul. 25, 2006 (JP) 2006-202119

(51) Int. Cl. B41J 29/38; B41J 2/01

(52) U.S. Cl. 347/16; 347/104

(57) ABSTRACT

A recording head has a nozzle orifice line, and performs recording on a recording medium. A transport roller transports the recording medium to a position opposite to the recording head. A control unit has information about a plurality of speed levels different from each other which are rotational speeds for constant speed regions of the transport roller, a plurality of recording modes for leading end margins and information about recording start positions different from each other in each recording mode, and includes an optimum transport speed selecting unit that, when any one of the recording modes is selected, compares a first distance from a recording medium sensor to the recording start position with a second distance from a deceleration start point to a stop point, and selects the highest speed level when the second distance is smaller than the first distance. After a leading end of the recording medium transported by the transport roller rotating at a constant speed of the selected speed level is detected by the recording medium sensor, the recording medium is transported as much as difference between the first and second distances at the constant speed, then is decelerated by the predetermined negative acceleration and stopped.

### BACKGROUND OF THE INVENTION

The present invention relates to a recording apparatus including a recording head that has nozzle orifice line and performs recording on a recording medium, a transport roller that transports the recording medium to a position opposite to the recording head, and a control unit that controls recording operations including the operations of the recording head and the transport roller, a method of transporting a recording medium and a liquid ejecting apparatus.

Here, the liquid ejecting apparatus is not limited to an ink jet-type recording apparatus, which performs a recording operation on a recording medium by ejecting ink from a recording head serving as a liquid ejecting head onto a recording medium, such as a recording paper, and a recording apparatus such as a copying machine or a facsimile, but, the liquid ejecting apparatus includes an apparatus that ejects and adheres liquid corresponding to a specific purpose, instead of ink, from a liquid ejecting head corresponding to the recording head onto an ejecting medium corresponding to the recording medium. Further, in addition to the above-described recording head, the liquid ejecting head includes a colored material ejecting head that is used to manufacture a color filter for a liquid crystal display, a conductive material (conductive paste) ejecting head used to form electrodes in an organic EL display or a field emission display (FED), a bioorganic ejecting head used to manufacture a biochip, and a sample ejecting head serving as a pipette through which sample is ejected.

Referring to an ink jet recording apparatus, a related paper transport method will be described. Recording paper stacked on a hopper is guided to a rear guide on a transport path by means of a transport roller and is then transported onto a platen opposite to a recording head by means of the transport roller. At this time, a sensor provided in the recording head detects the recording paper, and a control unit performs a control such that the leading end of the recording paper stops at the recording start position. At this time, the recording start position is set to be changed according to a recording mode for a leading end margin, such as a print mode with no margin, a print mode with 3 mm margin, or a print mode with 5 mm margin. In other words, the position at which the recording paper stops on the platen is changed according to the print mode. In the following description, a stop position at which the recording paper stops in the print mode with no margin, a stop position at which the recording paper stops in the print mode with 3 mm margin, and a stop position at which the recording paper stops in the print mode with 5 mm margin are set to be P1, P2, and P3, respectively. Next, the transport speed when the recording paper stops at the recording start position will be described.

A transport speed when a recording paper stops at the recording start position will be described below.

FIGS. 17A to 17C are graphs illustrating the relationship of the distance and speed when the recording paper is transported to the recording start position in the related art. The vertical axis of the graph indicates the speed of a driving motor that drives a driving roller for transporting a recording paper. In addition, the horizontal axis of the graph indicates the number of steps of the driving motor, that is, the distance by which the recording paper has been transported. First, the driving motor that stands still starts to move and then accelerates until a constant speed V1. Then, the driving roller transports the recording paper at a constant speed V1′ in the transport direction.

Then, the sensor detects a leading end of the recording paper. This corresponds to ‘sensor detection’ on the graph. Subsequently, since the leading end of the recording paper has been detected, the control unit stops the driving motor by decelerating at a predetermined negative acceleration such that the recording paper can be stopped at any one of the stop positions P1 to P3. FIG. 17A illustrates a graph when the recording paper is stopped at the stop position P1 in the print mode with no margin. Similarly, FIG. 17B illustrates a graph when the recording paper is stopped at the stop position P2 in the print mode with 3 mm margin, and FIG. 17C illustrates a graph when the recording paper is stopped at the stop position P3 in the print mode with 5 mm margin.

It is necessary to decelerate a driving motor in order to stop the driving motor that is driven in a constant speed. In addition, the number of steps of the driving motor, which is required from a time point when the driving motor starts to decelerate to a time point when the driving motor stops, is determined by a constant speed level immediately before the driving motor starts to decelerate.

Accordingly, in the related art, a speed corresponding to the constant speed V1 has been determined by performing a reverse calculation on the basis of the distance (the number of steps) to the stop position P1 that is closest to the sensor detection position in order to improve the throughput. Furthermore, for the variation of the stop position, the recording paper stops at each stop position by increasing-controlling the number of steps of the driving motor that is driven in the constant speed V1 after the sensor detection has been made (for example, refer to JP-A-2003-285483).

Further, in a related art, a recording apparatus is provided, which includes an input unit that inputs the value of the upper margin of paper, a motor that transports paper, a sensor that detects the leading end of the transported paper, and a paper transport processing unit that transports paper by controlling the motor. In the above-mentioned recording apparatus, the paper transport processing unit determines the speed of the paper depending on the value of the upper margin of the paper inputted from the input unit, and accelerates the motor to the predetermined speed and decelerates the motor when the sensor detects the leading end of the paper (see Japanese Patent No. 2898191).

However, in the related art (JP-A-2003-285483), the recording paper is transported in the same speed, such that the stop positions are different has not been sufficient to improve the throughput. In particular, an improvement of the throughput when the recording paper stops at the stop positions P2 and P3 other than the stop position P1 closest to the sensor detection position has not been sufficient.

Further, in Japanese Patent No. 2898191, because the transport speed of paper is variable, throughput may be improved. However, the recording apparatus is configured such that the transport speed of paper is determined depending on the upper margin of the paper, the paper is transported at the determined speed, and the motor is decelerated when the sensor detects the leading end of the paper, such that the motor at the determined speed should start being decelerated when the sensor detects the leading end of the paper.

Accordingly, when the transport speed of the paper is calculated, the size of a data table for the calculation increases and the calculation becomes complicated.

Further, in order to start decelerating the motor when the sensor detects the leading end of the paper, the relationship of the position of the sensor and the stop position of the paper is not optionally determined, but by absolute conditions. Therefore, the position of the sensor is limited to a narrow region and the apparatus can not be freely designed.

In addition, when the motor is decelerated right after the sensor detects the leading end of the paper, the apparatus is affected by the sensitivity of the sensor (time lag etc) and the paper may not be stopped at a desired position.

### SUMMARY

It is therefore an object of the invention to provide a recording apparatus in which the throughput is improved in the case in which the stop position of a recording medium varies when starting to record an image etc on the recording medium and paper can be stopped at a correct position even though the design is easy due to the compact disposition of the sensor, and a method of transporting the recording medium and liquid ejecting apparatus.

In order to achieve the object, according to the invention, there is provided a recording apparatus comprising:

a recording head that has a nozzle orifice line, and performs recording on a recording medium;

a transport roller that transports the recording medium to a position opposite to the recording head; and

a control unit that controls recording operations including operations of the recording head and the transport roller, and has information about a plurality of speed levels different from each other which are rotational speeds for constant speed regions of the transport roller, a plurality of recording modes for leading end margins and information about recording start positions different from each other in each recording mode, and includes an optimum transport speed selecting unit that, when any one of the recording modes is selected, compares a first distance from a recording medium sensor that is disposed an upstream side of the nozzle orifice line in a transport direction to the recording start position corresponding to the selected recording mode with a second distance, where the recording medium is transported by a predetermined negative acceleration, from a deceleration start point which is connected to the constant speed region to a stop point, and selects the highest speed level in the plurality of speed levels of the transport roller when the second distance is smaller than the first distance, wherein

after a leading end of the recording medium transported by the transport roller rotating at a constant speed of the selected speed level is detected by the recording medium sensor, the recording medium is transported as much as difference between the first and second distances at the constant speed, then is decelerated by the predetermined negative acceleration and stopped.

With this configuration, as any one of the recording modes is selected, the highest speed level at which the recording medium can be decelerated and stopped from a constant speed within a range not exceeding the first distance is selected. Then, the recording medium is transported by the transport roller that rotates at the selected highest speed level in accordance with the recording start position. Accordingly, the time required to transport the recording medium to the recording start position is reduced, which improves a so-called throughput.

Further, by configuring such that the first distance is large, it is possible to make the second distance as large as possible, the second distance being a distance until the recording medium starts decelerating and stops from a state in which the recording medium is transported at the constant speed. As a result, since the first distance is large, it becomes easy to select a high speed level as the constant speed. In other words, since it is possible to considerably reduce objects transported at a low speed level, the throughput can be further improved.

Further, since the recording medium is continually transported at the constant speed as much as the difference after the sensor detects the leading end of the recording medium, the apparatus becomes compact, flexibility of the design is not decreased in the disposition of the sensor and the paper can be exactly stopped at the desired position.

In order to achieve the object, according to the invention, there is also provided a recording apparatus comprising:

a recording head that has a nozzle orifice line, and performs recording on a recording medium;

a transport roller that transports the recording medium to a position opposite to the recording head; and

a control unit that controls recording operations including operations of the recording head and the transport roller, and has information about a plurality of deceleration curves different from each other which are deceleration regions connected to constant speed regions of the transport roller, a plurality of recording modes for leading end margins and information about recording start positions different from each other in each recording mode, wherein

when any one of the recording modes and any one of the deceleration curves are selected, a first distance is defined as a distance from a recording medium sensor that is disposed an upstream side of the nozzle orifice line in a transport direction to the recording start position corresponding to the selected recording mode and a second distance is defined as a distance, where the recording medium is transported by the selected deceleration curve, from a deceleration start point to a stop point, and

after a leading end of the recording medium transported by the transport roller is detected by the recording medium sensor, the recording medium is transported as much as difference obtained by subtracting the second distance from the first distance at a constant speed, then is decelerated based on the deceleration curve and stopped at the recording start position.

With this configuration, when the leading end of the recording medium is transported and stopped at each recording start position corresponding to the modes, the other stopping method may be available by separately using the decelerating curves.

For example, considering improvement of the throughput, the constant speed region before the deceleration starts can be increased by selecting a high deceleration curve in which the recording medium is rapidly decelerated and the throughput can be easily improved. On the other hand, considering the quality of the product rather than the throughput, the recording medium can be exactly stopped at the desired position by slowly decelerating the recording medium.

The control unit may have information about a plurality of speed levels different from each other which are rotational speed for constant speed regions of the transport roller, and include an optimum transport speed selecting unit that selects the highest speed level in the plurality of speed levels of the transport roller when the second distance corresponding to each speed level is smaller than the first distance, and

after the leading end of the recording medium transported by the transport roller rotating at a constant speed of the selected speed level is detected by the recording medium sensor, the recording medium is transported as much as difference between the first and second distances at the constant speed, then is decelerated based on the deceleration curve and stopped.

In this case, when the recording medium is stopped at different recording start positions corresponding to the modes, the recording medium can be transported by rotating the transport roller at a high speed and the throughput can be improved in a case where the second distance is smaller than the first distance.

The optimum transport speed selecting unit may compare the second distance with the first distance in order of high speed in the plurality of speed levels.

In this case, it is possible to quickly and easily select a speed level suitable for the condition, as compared with a case in which the distances are compared and selected in the order of low speed or in the predetermined order.

The plurality of recording modes may include a recording mode with no margin, a 3 mm margin mode and a 5 mm margin mode.

In this case, the recording mode about the leading end margin is limited to three types, such that the calculation of transport distance by the constant speed before the deceleration is started by the control unit is simplified.

The plurality of speed levels of the transport roller may include three patterns of high speed, middle speed and low speed.

In this case, the calculation of transport distance by the constant speed before the deceleration is started by the control unit can be simplified.

The deceleration curves of the transport roller may include three patterns of deceleration speed with steep slope, middle slope and gentle slope.

In this case, the calculation of transport distance by the constant speed before the deceleration is started by the control unit can be simplified.

In order to achieve the object, according to the invention, there is also provided a method of transporting a recording medium that is transported by a transport roller to a recording start position opposite to a recording head having a nozzle orifice line and performing recording on the recording medium and that is stopped, the method comprising:

selecting any one of recording modes from a plurality of recording modes for leading end margins;

determining the recording start position corresponding to the selected recording mode,

selecting the highest speed level in speed levels at which a first distance from a recording medium sensor that is disposed an upstream side of the nozzle orifice line in a transport direction to the determined recording start position is larger than a second distance, where the recording medium is transported by a predetermined negative acceleration, from a deceleration start point which is connected to a constant speed region to a stop point; and

after a leading end of the recording medium transported by the transport roller rotating at a constant speed of the selected speed level is detected by the recording medium sensor, transporting the recording medium as much as difference between the first and second distances at the constant speed, then decelerating the recording medium by the predetermined negative acceleration and stopping the recording medium.

In order to achieve the object, according to the invention, there is also provided liquid ejecting apparatus comprising:

a liquid ejecting head that has a nozzle orifice line, and performs liquid ejecting on an ejecting medium;

a transport roller that transports the ejecting medium to a position opposite to the liquid ejecting head; and

a control unit that controls liquid ejecting operations including operations of the liquid ejecting head and the transport roller, and has information about a plurality of speed levels different from each other which are rotational speeds for constant speed regions of the transport roller, a plurality of liquid ejecting modes for leading end margins and information about liquid ejecting start positions different from each other in each liquid ejecting mode, and includes an optimum transport speed selecting unit that, when any one of the liquid ejecting modes is selected, compares a first distance from an ejecting medium sensor that is disposed an upstream side of the nozzle orifice line in a transport direction to the liquid ejecting start position corresponding to the selected liquid ejecting mode with a second distance, where the ejecting medium is transported by a predetermined negative acceleration, from a deceleration start point which is connected to the constant speed region to a stop point, and selects the highest speed level in the plurality of speed levels of the transport roller when the second distance is smaller than the first distance, wherein

after a leading end of the ejecting medium transported by the transport roller rotating at a constant speed of the selected speed level is detected by the ejecting medium sensor, the ejecting medium is transported as much as difference between the first and second distances at the constant speed, then is decelerated by the predetermined negative acceleration and stopped.

In order to achieve the object, according to the invention, there is also provided a liquid ejecting apparatus comprising:

a liquid ejecting head that has a nozzle orifice line, and performs liquid ejecting on an ejecting medium;

a transport roller that transports the ejecting medium to a position opposite to the liquid ejecting head; and

a control unit that controls liquid ejecting operations including operations of the liquid ejecting head and the transport roller, and has information about a plurality of deceleration curves different from each other which are deceleration regions connected to constant speed regions of the transport roller, a plurality of liquid ejecting modes for leading end margins and information about liquid ejecting start positions different from each other in each liquid ejecting mode, wherein

when any one of the liquid ejecting modes and any one of the deceleration curves are selected, a first distance is defined as a distance from an ejecting medium sensor that is disposed an upstream side of the nozzle orifice line in a transport direction to the liquid ejecting start position corresponding to the selected liquid ejecting mode and a second distance is defined as a distance, where the ejecting medium is transported by the selected deceleration curve, from a deceleration start point to a stop point, and

after a leading end of the ejecting medium transported by the transport roller is detected by the ejecting medium sensor, the ejecting medium is transported as much as difference obtained by subtracting the second distance from the first distance at a constant speed, then is decelerated based on the deceleration curve and stopped at the liquid ejecting start position.

The control unit may have information about a plurality of speed levels different from each other which are rotational speed for constant speed regions of the transport roller, and include an optimum transport speed selecting unit that selects the highest speed level in the plurality of speed levels of the transport roller when the second distance corresponding to each speed level is smaller than the first distance, and

after the leading end of the ejecting medium transported by the transport roller rotating at a constant speed of the selected speed level is detected by the ejecting medium sensor, the ejecting medium is transported as much as difference between the first and second distances at the constant speed, then is decelerated based on the deceleration curve and stopped.

### BRIEF DESCRIPTION OF THE DRAWINGS

FIG. 1 is a perspective view illustrating the exterior of an ink jet printer.

FIG. 2 is a perspective view illustrating the interior of the ink jet printer.

FIG. 3 is a side view schematically illustrating the ink jet printer.

FIG. 4 is a side view illustrating the recording start position of a recording paper in the vicinity of a recording head.

FIGS. 5A to 5C are graphs illustrating distance and speed when a recording paper is transported to the recording start position in the invention.

FIG. 6 is a block diagram of the recording apparatus of the first embodiment.

FIG. 7 is a flow chart illustrating a method of transporting a recording paper to each recording starting position in the recording apparatus.

FIG. 8 is a graph showing the relationship of the time and speed for transporting a recording paper to the recording start position of the invention.

FIG. 9 is a graph showing the speed and distance for transporting a recording paper to the recording start position (stop position) or difference deceleration curves in the recording apparatus of the second embodiment.

FIG. 10 is a block diagram of the recording apparatus.

FIG. 11 is a flow chart illustrating a method of transporting recording paper to each recording start position in the recording apparatus.

FIG. 12 is a graph showing the speed and distance for transporting a recording paper to the recording start position (stop position) or difference deceleration curves in the recording apparatus of the third embodiment.

FIG. 13 is a block diagram of the recording apparatus.

FIG. 14 is a flow chart illustrating a method of transporting recording paper to each recording start position in the recording apparatus.

FIG. 15 is a flow chart illustrating a method of transporting recording paper to each recording start position in the recording apparatus.

FIG. 16 is a flow chart illustrating a method of transporting recording paper to each recording start position in the recording apparatus.

FIGS. 17A to 17C are graphs illustrating distance and speed when a recording paper is transported to the recording start position in the related art.

### DETAIL DESCRIPTION OF PREFERRED EMBODIMENTS

Hereinafter, an ink jet printer 100 will be described by way of an example of a recording apparatus included in a liquid ejecting apparatus according to the invention with reference to the accompanying drawings.

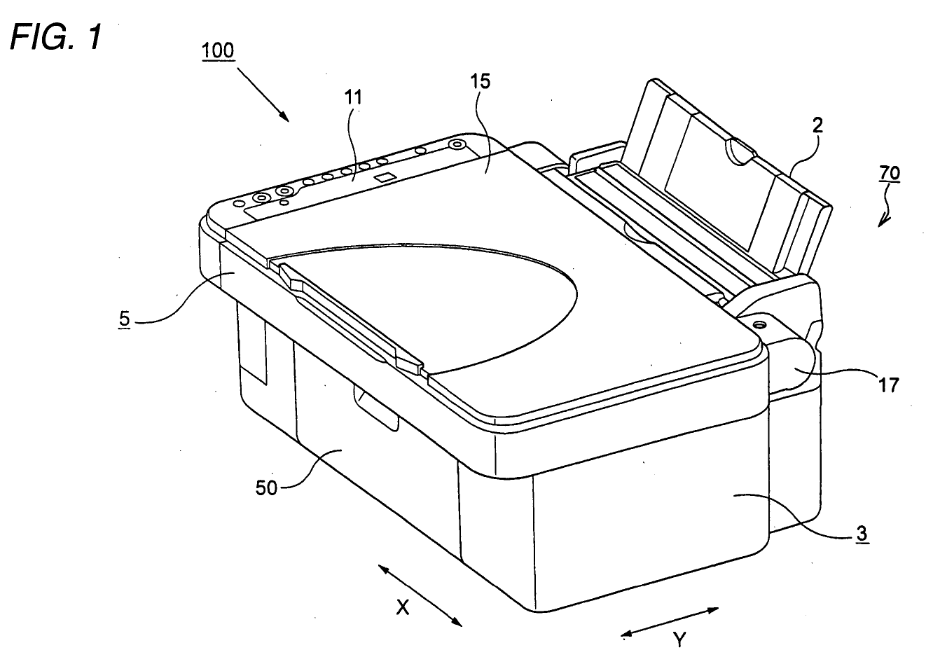

First, the overall configuration of the ink jet printer 100 will be schematically described with reference to FIGS. 1 to 3.

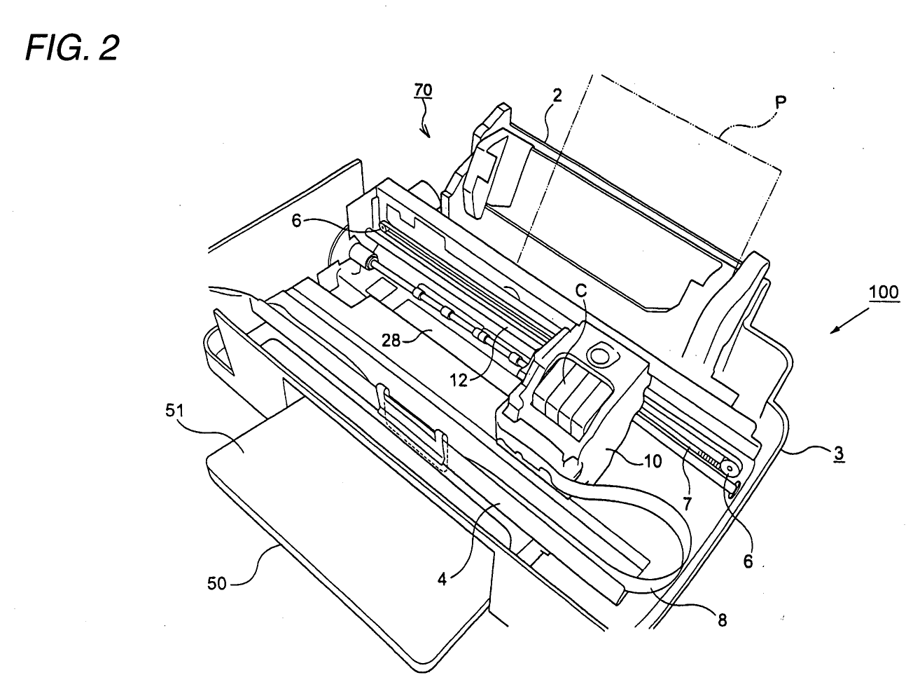

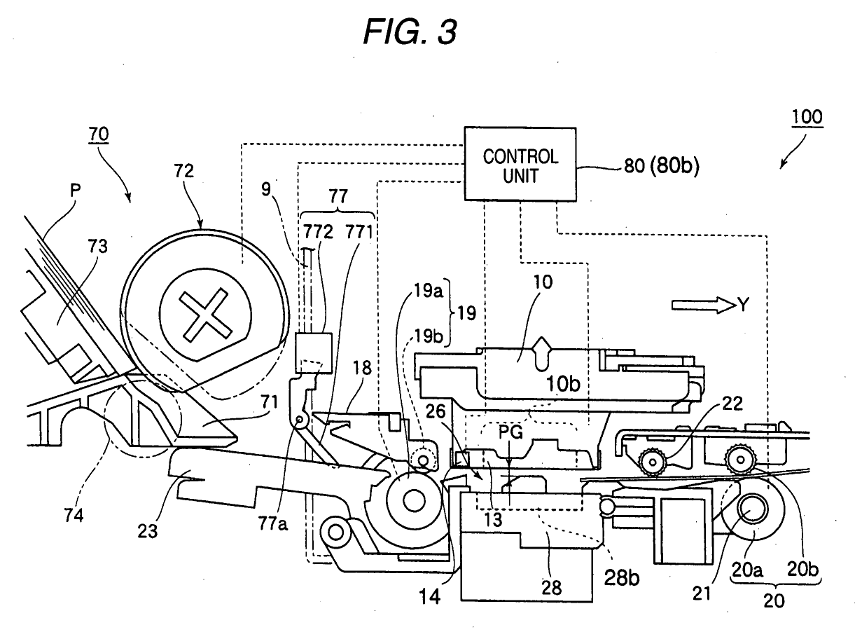

FIG. 1 is a perspective view illustrating the exterior of the ink jet printer 100, FIG. 2 is a perspective view illustrating the interior of the ink jet printer 100, and FIG. 3 is a side view schematically illustrating the ink jet printer 100.

The ink jet printer 100 includes an automatic paper feed device 70 at the rear side of the main body of the recording apparatus 3. Further, in the ink jet printer 100, a recording operation on the recording paper P fed from the automatic paper feed device 70 is performed and then the recording paper P is transported to an ejection stacker 50 that is located at a lower front side of main body of the recording apparatus 3.

The ink jet printer 100 also includes a scanner unit 5 having a cover 15 that can be opened and closed with respect to an upper surface of a main body 3 (see FIG. 1). The scanner unit 5 has an operation panel 11 provided on a side thereof, such that image scanning, digital image recording, or the like can be performed at the same time by using the operation panel 11. The scanner unit 5 can rotate upward around a rotary shaft 17. Accordingly, as shown in FIG. 2, an upper surface of the main body 3 is opened such that a user can access a carriage 10, a platen 28, and the like, which will be described later, located inside the ink jet printer 100.

A transport path of the recording paper P in the ink jet printer 100 is shown in FIG. 3. The automatic paper feed device 70 includes a hopper 73 that can rotate around a rotary shaft (not shown) clockwise and counterclockwise in FIG. 3 and support the recording paper P in an inclined manner together with the paper feed tray 2. A leading end of the recording paper P, which is stacked on the hopper 73 in the inclined manner, is supported by a frame 71 of the automatic paper feed device 70. In addition, when the leading end of the recording paper P slidably comes in contact with the frame 71 of the automatic paper feed device 70 according to a swing operation of the hopper 73, uppermost recording paper P is pressed against paper transport roller 72.

The paper transport roller 72 has approximately a D shape having an arc portion and a straight-line portion in side view. In addition, a rubber material is rolled up on an outer surface of the paper transport roller 72 such that the arc portion can come in contact with a separation roller 74 provided below the paper transport roller 72. The separation roller 74 is rotatably driven or prevented from being rotatably driven in the rotational direction (counterclockwise in FIG. 3) in which the recording paper P moves upstream. Further, since a press point is formed between the separation roller 74 and the paper transport roller 72 that is rotatably driven in the counterclockwise in FIG. 3 when the recording paper P is fed, the separation roller 74 serves to separate uppermost recording paper P, which is to be fed, from the other recording paper P that is willing to be transported together with uppermost recording paper P. The recording paper P moving downstream from the press point between the paper transport roller 72 and the separation roller 74 is guided to a transport roller 19 by a rear guide 23. Here, the transport roller 19 includes a driving roller 19a for transporting the recording paper P (hereinafter, simply referred to as a ‘driving roller 19a’) and a follower roller 19b for transporting the recording paper P (hereinafter, simply referred to as a ‘follower roller 19b’), which transport the recording paper P in a predetermined transport direction (sub-scanning direction Y) by a predetermined transport amount.

The rear guide 23 has a shape that is long in the width direction (main scanning direction X) of the recording paper P. In this embodiment, the rear guide 23 is made of a resin material, extends in the main scanning direction X, and is disposed to pass through an opening formed in a main frame 9 that is vertically provided. Above the rear guide 23, a first sensor 77 having a paper detection lever 771, which swings around a swing shaft 77a due to coming in contact with the recording paper P, and a paper detection sensor 772, which detects the swing of the paper detection lever 771, is provided. The first sensor 77 detects leading and trailing ends of the recording paper P.

Further, the recording paper P that has been transported to the transport roller 19 is inserted and held (nipped) between the driving roller 19a and the follower roller 19b, is transported in the sub-scanning direction Y perpendicular to the main scanning direction X by the rotation of the driving roller 19a, and then is transported to a region (recording position 26) facing the recording head 13. A plurality of follower rollers 19b is provided in the width direction of the recording paper P, and each of the plurality of follower rollers 19b is supported by a roller holder 18 so as to be rotatably driven. The roller holder 18 is pressed by a pressing unit (not shown), which causes the follower roller 19b to be pressed against the driving roller 19a.

The recording paper P, which is transported while being inserted and held (nipped) between the driving roller 19a and the follower roller 19b, is pressed downward by means of an auxiliary press roller (not shown) and a press plate (not shown), which are respectively provided in the vicinity of the follower roller 19b and at the downstream of the sub-scanning direction Y, and is then guided to the recording position 26 located below the recording head 13 in a state in which the recording paper P is prevented from rising. A reciprocating operation of a carriage 10 in the main scanning direction X and a transport operation of the recording paper P in the sub-scanning direction Y are alternately performed on the recording paper P guided to the recording position 26 so as to perform a recording operation, the carriage 10 being included in a ‘recording execution unit (liquid ejecting execution unit)’ that performs the recording operation on the recording paper P.

The recording head 13 that forms dots on a recording surface of the recording paper P by jetting, i.e. ejecting ink on the basis of record data is mounted on a bottom surface of the carriage 10. On an upper surface of the carriage 10, an ink cartridge corresponding to each of the colors, such as black, cyan, magenta, or yellow, is detachably mounted, as shown in FIG. 2. Further, a part of an endless belt 7, which is stretched over pulleys 6 provided at both ends of the main scanning direction X, is connected to the carriage 10. The carriage 10 is supported by a carriage guide shaft 12 so as to be able to reciprocate in the main scanning direction X and reciprocates in the main scanning direction X by a driving force from a motor (not shown). Furthermore, a flat flexible cable (hereinafter, referred to as a ‘FFC’) 8 having a band shape is connected to the carriage 10, the FFC 8 being provided along a frame 4 located at the front side of the carriage 10. The FFC 8 serves to transmit information, such as the amount of remaining ink of the ink cartridge C mounted on the carriage 10, to a control unit 80.

Below the recording head 13, a platen 28 that faces a head surface of the recording head 13 and supports the recording paper P from beneath is provided. The platen gap PG between the recording head 13 and the platen 28 can be properly adjusted according to the thickness variation of the recording paper P by appropriately setting the space between the surface of the recording paper P and the head surface.

In addition, the carriage 10 is provided with a recording medium sensor 14 as a second sensor so as to be opposite to the platen 28. The recording medium sensor 14, a second sensor, which is disposed at an upstream side of the recording head 13 in the sub-scanning direction Y in the transport path, so as to be able to detect the end portion of the recording paper P without coming in contact with the recording paper P. The recording medium sensor 14 includes a light-emitting unit (not shown) that emits light toward the platen 28 and a receiving unit (not shown) that receives light reflected from the platen 28. The recording medium sensor 14 detects edge locations (both ends, a leading end, and a trailing end) of the recording paper P by using a difference between the reflectivity of the recording paper P and the reflectivity of the platen 28, and thus the positions of the leading end, trailing end, and both ends, the length, and the width (paper width) of the recording paper P can be specified. Here, the reflectivity of the recording paper P is high and the reflectivity of the platen 28 made of a black material is low.

At the downstream side of the recording head 13 in the sub-scanning direction Y, an ejection roller 20 including a driving roller 20a for ejection and a follower roller 20b for ejection is provided. The recording paper P ejected by the ejection roller 20 is ejected onto a top surface 51 of the ejection stacker 50. The driving roller 20a for ejection is provided on an outer circumferential surface of an ejection roller shaft 21. The follower roller 20b for ejection is a spur roller having a plurality of teeth on an outer circumferential surface thereof, and is rotatably supported by a roller holder for the follower roller 20b for ejection. Further, an auxiliary follower roller 22 is provided at the upstream side of the follower roller 20b for ejection, and the recording paper P is pressed slightly downward by the auxiliary follower roller 22. An axial center of the follower roller 19b is positioned slightly downstream as compared with that of the driving roller 19a. An axial center of the follower roller 20b for ejection is positioned slightly upstream as compared with that of the driving roller 20a for ejection.

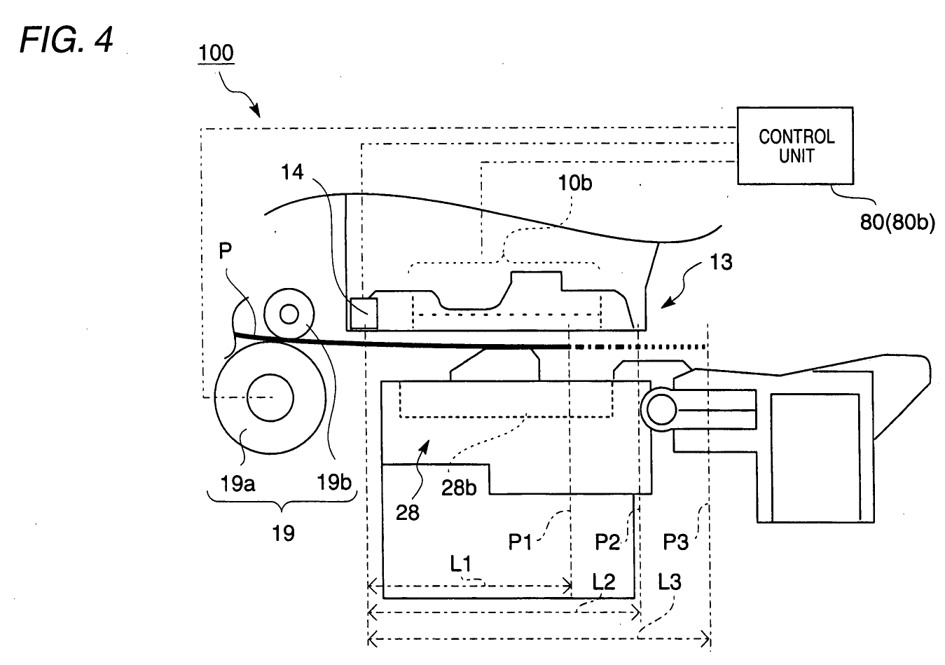

FIG. 4 is a side view illustrating the recording start position of a recording paper in the vicinity of a recording head.

As shown in FIG. 4, a line of nozzle orifices (hereinafter, referred to as a ‘nozzle orifice line’) 10b, through which ink can be ejected onto the recording paper P, is provided on a lower surface of the recording head 13. Further, the platen 28 is provided with a drain groove 28b to which ink ejected from the nozzle orifice line 10b is thrown away. The drain groove 28b is provided with an ink absorber (not shown) that can absorb ink. The drain groove 28b is slightly longer than the nozzle orifice line 10b in the transport direction. In addition, the recording medium sensor 14 is provided at the upstream side of the recording head 13 in the transport direction, and the recording medium sensor 14 is located between the transport roller 19 and the nozzle orifice line 10b.

Furthermore, reference numeral P1 to P3 indicates recording start positions set for each recording mode, that is, stop positions of the recording paper P transported when a recording operation starts by the recording head 13. In this embodiment, three types of recording modes, that is, a print mode with no margin, a print mode with 3 mm margin, and a print mode with 5 mm margin are set.

In the case of the recording mode with no margin, the leading end of the recording paper P stops at the stop position P1 within a range opposite to the nozzle orifice line 10b such that the recording operation can be performed up to a leading end (downstream end) of the recording paper P in the transport direction. Further, in the case of the print mode with 3 mm margin, the leading end of the recording paper P stops at the stop position P2, which is located 3 mm away from a downstream end of the nozzle orifice line 10b in the transport direction, such that 3 mm margin exists in the leading end portion of the recording paper P. Similarly, in the case of the print mode with 5 mm margin, the leading end of the recording paper P stops at the stop position P3, which is located 5 mm away from the downstream end of the nozzle orifice line 10b in the transport direction, such that 5 mm margin exists in the leading end portion of the recording paper P.

Here, a distance from the recording medium sensor 14 to each of the recording start positions P1, P2 and P3 is mechanically determined, which is the first distance in the invention. In the following description, a distance from the recording medium sensor 14 to the stop position P1 is set as a first distance L1, to the stop position P2 is set as a first distance L2, and to the stop position P3 is set as a first distance L3. At this time, the recording medium sensor 14 is set at the upstream end of the recording head 13 in the transport direction so that the first distance L1 to L3 can be as large as possible.

In the ink jet printer 100 having the configuration described above, the control unit 80 performs an automatic paper feed control using a rotation control with respect to the paper transport roller 72, a control of transporting the recording paper P using a rotation control with respect to the driving roller 19a and the driving roller 20a for ejection, and an ink ejection control using a driving control with respect to the recording head 13 and a reciprocating operation of the carriage 10, thereby executing a recording operation on the recording paper P (FIGS. 3 and 4). In addition, detection signals, which are detected by the first sensor 77 and the recording medium sensor 14, indicating the position of an end portion of the recording paper P, are input to the control unit 80, and the control unit 80 performs each of the controls on the basis of the detection signals.

### First Embodiment

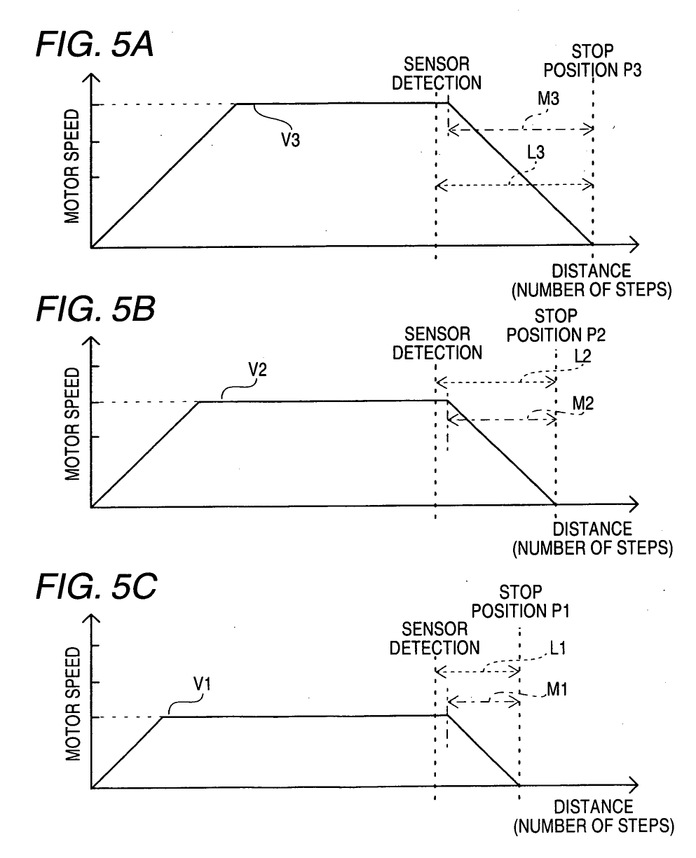

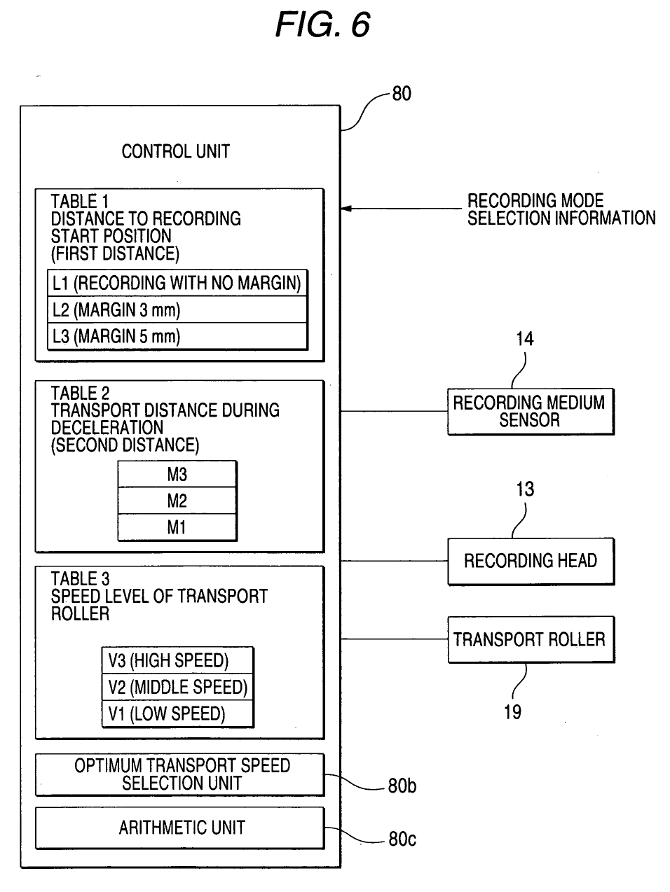

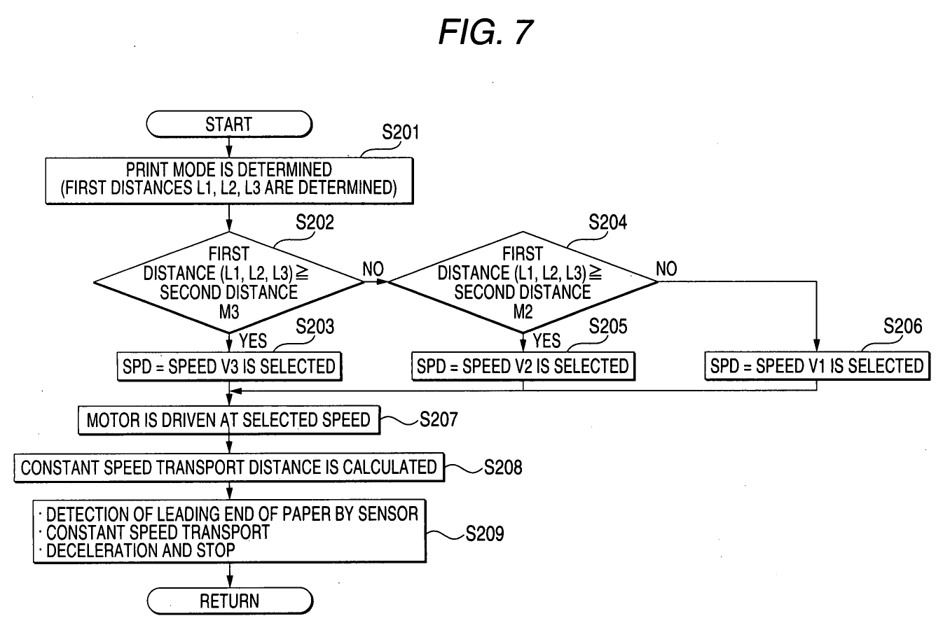

A first embodiment of a recording apparatus of the invention is described below with reference to FIGS. 4 to 7. FIGS. 5A to 5B show graphs illustrating the relationship of the transport speed of a recording paper to the recording start position (stop position) and the distance, FIG. 6 is a block diagram of the recording apparatus, and FIG. 7 is a flow chart of a method of transporting recording papers to each recording start position in the recording apparatus. FIG. 5A is a graph in the case when the recording paper stops at the stop position P3, FIG. 5B is a graph in the case when the recording paper stops at the stop position P2, and FIG. 5C is a graph in the case when the recording paper stops at the stop position P1. Further, the vertical axes of the graphs indicate the speed of a driving motor, and the horizontal axes of the graphs indicate the number of steps of the driving motor, that is, the distance by which the recording paper has been transported.

Here, the driving motor (not shown) means a motor that drives the driving roller 19a of the transport roller 19. Accordingly, the rotational speed of the driving motor generally corresponds to the rotational speed of the transport roller 19.

In this embodiment, the speed level of the driving motor, i.e. the transport roller 19 is a rotational speed in a constant speed region and set to three patterns of high speed V3, middle speed V2, and low speed V1 in high speed order. In addition, the acceleration when the driving motor accelerates and the negative acceleration when the driving motor decelerates are constant. Therefore, the transported distance, which is required during the deceleration from a time point when the driving motor, i.e. the transport roller 19 rotates in a constant speed and transports the recording paper P to a time point when the driving motor starts to decelerate and stops, can be calculated on the basis of the negative acceleration and the constant speed immediately before the driving motor starts to decelerate.

The second distance of the invention is the transported distance connected to the constant speed region, during deceleration, from starting deceleration and stop. In this embodiment, the speed level of the driving motor, i.e. the transport roller 19 is set to the above-mentioned three patterns (V3, V2, and V1). A second distance M3 is the transported distance from starting deceleration and stop after the motor has been driven at high speed V3 (FIG. 5A), a second distance M2 is the transported distance from starting deceleration and stop after the motor has been driven at middle speed V2, and a second distance M1 is the transported distance from starting deceleration and stop after the motor has been driven at low speed V1 (FIG. 5C).

As shown in FIG. 6, a control unit 80 in this embodiment has three recording modes of ‘recording mode with no margin’, ‘3 mm margin mode’, and ‘5 mm margin mode’ with respect to the leading margin of a recording paper P and the first distance (L1, L2, L3) in Table 1 that is information on the different recording start position P1, P2, P3 in each of the modes.

Further, the information about the three speed level of the transport roller 19 (high speed V3, middle speed V2, low speed V1) is in Table 3 and the second distance (M3, M2, M1) that is the distance during deceleration corresponding to each speed level (V3, V2, V1) is in Table 2.

The control unit 80 has an optimum transport speed selecting unit 80b that, when any one of the recording modes is selected, compares the first distance corresponding to the selected recording mode with the second distance corresponding to a speed level tentatively selected in a predetermined order, and selects the highest speed level in the three speed level (V3, V2, V1) of the transport roller 19 when a condition that the second distance is smaller than the first distance is satisfied. In this embodiment, the optimum transport speed selecting unit 80b, in the high speed level order of the three speed level (V3, V2, and V1), compares the second distance and the first distance in the order of M3 →M2→M1 and selects a speed level under the above-mentioned condition.

The control unit 80 has an arithmetic unit 80c for calculating a constant speed transport distance. The arithmetic unit 80c calculates the distance transported at a constant speed after the recording medium sensor 14 detects the leading end of a recording paper that is transported by the transport roller 19 rotated at a constant speed of a speed level selected by the optimum transport speed selecting unit 80b. The constant speed transport distance is obtained as the difference between the first and second distances.

Subsequently, the operation of the first embodiment is described. A user selects any one of the ‘recording mode with no margin’, ‘3 mm margin mode’, and ‘5 mm margin mode’ using a selecting unit (not shown), such as known selecting switch, and the selecting information of the recording mode is, as shown in FIG. 6, sent to the control unit 80.

In the control unit 80, as shown in FIG. 7, the first distance (any one of L1 to L3) corresponding to any one of the recording start positions (stop position) P1, P2, P3 is determined (Step S201, which is simply referred to as S201 hereinafter).

Subsequently, the control unit 80 compares the first distance (any one of the first distance L1 to L3) with the second distance M3, which is corresponding to the high speed V3, during deceleration from the starting deceleration to stop. Then, if the control unit 80 determines that the first distance (any one of the first distance L1 to L3) is larger than the second distance M3 or that the first distance (any one of the first distance L1 to L3) is equal to the second distance M3, the speed level V3 is selected by the optimum transport speed selecting unit 80b (S203).

For example, in the case when the user selects the ‘print mode with 5 mm margin’, the stop position of the leading end of a recording paper is P3. Thus, the first distance L3 is determined (S201). Then, the optimum transport speed selecting unit 80b compares the first distance L3 with the second distance M3. Then, if the optimum transport speed selecting unit 80b determines that the first distance L3 is larger than the second distance M3 (S202), SPD=speed V3, the speed level V3 (high speed) is selected (S203). When the first distance L3 is the same as the second distance M3 (S202), the speed level (high speed) is also selected (S203).

As shown in FIG. 5A, the speed of the driving motor, i.e. the transport roller 19 is accelerated by a constant acceleration up to the selected speed V3 (high speed), thereafter keeps the speed V3 (high speed) and transports a recording paper P at a constant transport speed V3′ (S207).

The arithmetic unit 80c calculates the constant transport distance by subtracting the second distance M3 from the first distance L3 while the transport roller 19 transports the recording paper P at the constant transport speed V3′ (S208). Further, the constant speed transport distance may be obtained before the transport roller 19 starts transporting the recording paper P at the constant transport speed V3′.

A detected signal when the recording medium sensor 14 detects the leading end of a transported recording paper P is sent to the control unit 80 (S209). The driving motor more rotates at the constant speed V3 (high speed) as much as the step corresponding to the constant speed transport distance (L3 -M3) and keeps the constant speed transport (S209), thereafter changes in deceleration and starts decelerating, and stops to stop the leading end of the recording paper P at the stop position P3 (S209).

When the first distance L3 and the second distance M3 are the same (L3 -M3=0), the recording medium sensor 14 detects the leading end of the recording paper P and the leading end of the recording paper P is stopped at the stop position P3, at the same time. However, when the recording medium sensor 14 is disposed an upstream side of the recording head 13 in the transport direction as in this embodiment, the difference, L3-M3, is generally not 0. Further, such a configuration is preferable. This relationship is similar to the following relationships of L2 and M2, and L1 and M1.

Further, in the case when the user selects the ‘print mode with 3 mm margin’, the stop position of the leading end of a recording paper P is P2. Accordingly, the first distance L2 is calculated (S201). Subsequently, the optimum transport speed selecting unit 80b compares the first distance L2 with the second distance M3 (S202). As is apparent in FIGS. 5A and 5B, the optimum transport speed selecting unit 80b determines that the first distance L2 is smaller than the second distance M3, proceeding to step S204.

In step S204, the optimum transport speed selecting unit 80b compares the first distance L2 with the second distance M2 corresponding to the speed V2 (middle speed) smaller than the speed V3 (high speed). Then, if the optimum transport speed selecting unit 80b determines that the first distance L2 is larger than the second distance M2 (S204), SPD=speed V2, the speed level V2 (middle speed) is selected (S205). Further, the first distance L2 and the second distance M2 are the same (S204), the speed level V2 (middle speed) is also selected (S205).

Then, as shown in FIG. 5B, the driving motor, i.e. the transport roller 19 constantly accelerates up to the selected speed V2 (middle speed), thereafter keeps the constant speed V2 (middle speed), and transports the recording paper P at a constant transport speed V2′ (S207).

The arithmetic unit 80c calculates the constant speed transport distance by subtracting the second distance M2 from the first distance L2 (L2-M2) while the transport roller 19 transports the recording paper P at the constant transport speed V2′ (S208). Further, the constant speed transport distance may be obtained before the transport roller 19 starts transporting the recording paper at the constant transport speed V2′.

A detected signal when the recording medium sensor 14 detects the leading end of a recording paper P is sent to the control unit 80 (S209). The driving motor more rotates at the constant speed V2 (middle speed) as much as the step corresponding to the constant speed transport distance (L2-M2) and keeps the constant speed transport (S209), thereafter changes in deceleration and starts decelerating, and stops to stop the leading end of the recording paper P at the stop position P2 (S209).

Furthermore, in the case when the user selects the ‘recording mode with no margin’, the stop position P of the leading end of a recording paper is P1. Accordingly, the first distance L1 is determined (S201). Subsequently, the optimum transport speed selecting unit 80b compares the first distance L1 with the second distance M3 (S202). As is apparent in FIGS. 5A and 5C, the optimum transport speed selecting unit 80b determines that the first distance L1 is smaller than the second distance M3, proceeding to step S204.

In step S204, the optimum transport speed selecting unit 80b compares the first distance L1 with the second distance M2. Then, as is apparent in FIGS. 5B and 5C, the optimum transport speed selecting unit 80b determines that the first distance L1 is smaller than the second distance M2, proceeding to step S206. In step S206, the speed V1 (low speed) lower than the speed V2 (middle speed) is selected as SPD=speed V1.

When the pattern of speed levels V3, V2, V1 of the transport roller is separated into 4 or more, the optimum transport speed selecting unit 80b in step S206 determines as in step S204, and repeats the determination until the speed level is the other speed level and selects an optimum transport speed.

Then, as shown in FIG. 5C, the driving motor, i.e. the transport roller 19 constantly accelerates up to the selected speed V1 (low speed), thereafter keeps the constant speed V1 (low speed) and transports the recording paper P at a constant transport speed V1′ (S207).

The arithmetic unit 80c calculates the constant speed transport distance by subtracting the second distance M2 from the first distance L1 (L1-M1) while the transport roller 19 transports the recording paper P at the constant transport speed V1′ (S208). Further, the constant speed transport distance may be obtained before the transport roller 19 starts transporting the recording paper at the constant transport speed V1′.

A detected signal when the recording medium sensor 14 detects the leading end of a recording paper P is sent to the control unit 80 (S209). The driving motor more rotates at the constant speed V1 (low speed) as much as the step corresponding to the constant speed transport distance (L1-M1) and keeps the constant speed transport (S209), thereafter changes in deceleration and starts decelerating, and stops to stop the leading end of the recording paper P at the stop position P1 (S209).

As described above, after the leading end of a recording paper P is stopped at any one of the stop position P1, P2, P3, a carriage 10 moves in the main scanning direction and the recording of the selected mode by a user is started.

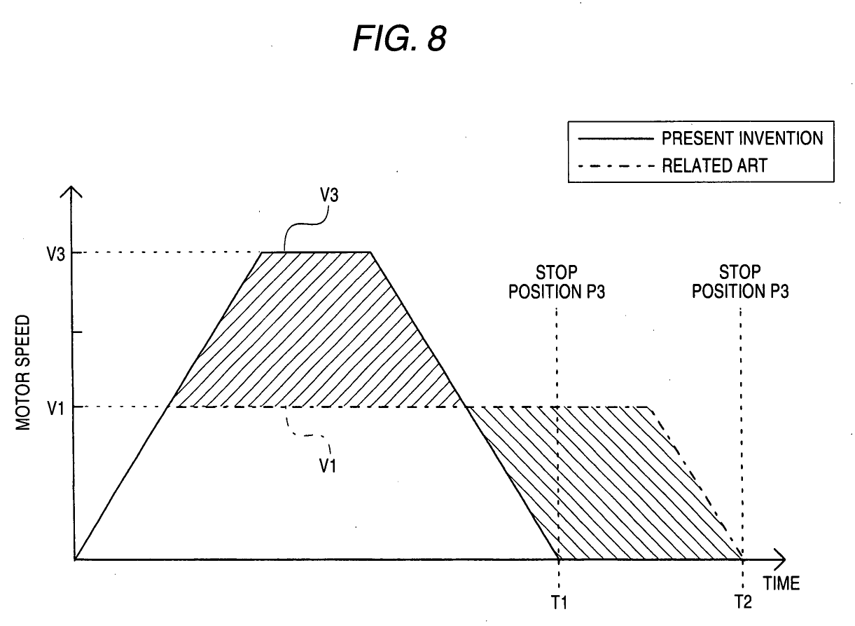

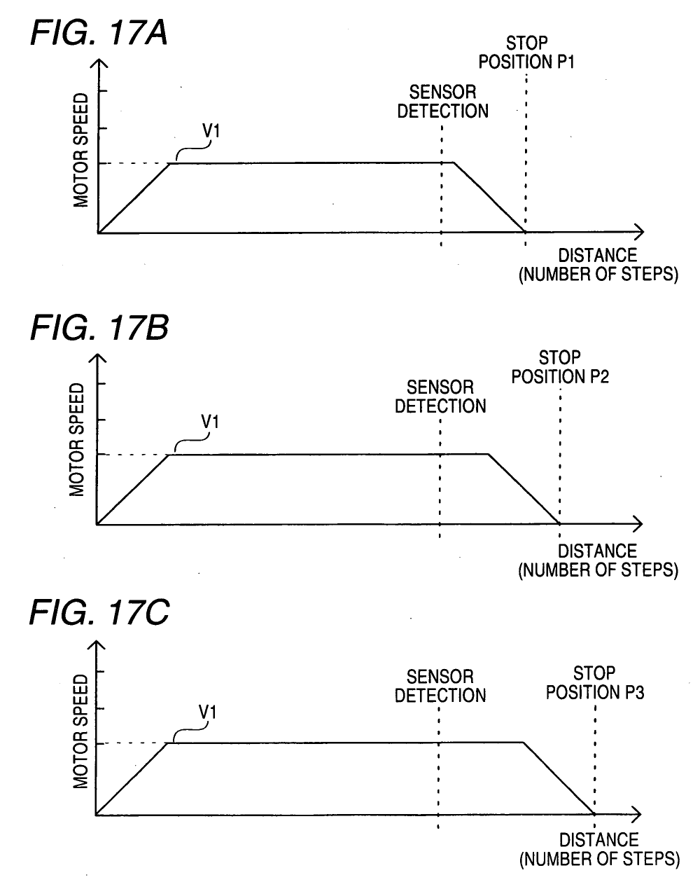

FIG. 8 is a graph illustrating the relationship of time and speed when the recording paper P is transported to the stop position P3 which is the recording start position in the first embodiment. The vertical axis of the graph indicates the speed of the driving motor, and the horizontal axis of the graph indicates time. A solid line corresponds to the transport method of this embodiment, and a dotted line corresponds to a transport method of the related art. Both of the lines indicate the time and speed until the recording paper P stops at the stop position P3. At this time, the transport method according to this embodiment corresponds to FIG. 5A, and the transport method according to the related art corresponds to FIG. 17C.

As shown in FIG. 8, in the transport method according to the invention, the driving motor keeps the constant speed V3 and rotates at the constant speed V3, thereby transporting the recording paper P at the constant transport speed V3′. Then, after the recording medium sensor 14 detects the leading end of the recording paper P, the recording paper P is transported as much as the constant speed transport distance at the constant speed V3 (constant transport speed V3′). Deceleration starts and the leading end of the recording paper P is stopped at the stop position P3. The time required for this is T1.

On the other hand, in the transport method according to the related art, the driving motor accelerates up to the speed V1 and rotates in the constant speed V1, thereby transporting the recording paper P at the constant transport speed V1′. Then, after the second sensor 14 detects the leading end of the recording paper P, the recording paper P is transported as much as a predetermined distance and decelerated such that the leading end of the recording paper P is stopped at the stop position P3. The time required for this is T2.

In the graph shown in FIG. 8, the area of a solid-line trapezoid indicates the distance by which the recording paper P has been transported when the transport method according to the invention is used, and the distance by which the recording paper P has been transported is the first distance L3. Further, since the leading end of the recording paper P stops at the stop position P3 in both the methods, it is clear that the area of the solid-line trapezoid is equal to that of a dot-line trapezoid. Furthermore, the speed V3 is larger than the speed V1, that is, V3>V1. Furthermore, it is clear that the area of the solid-line trapezoid indicated by right-oblique lines is equal to that of the dot-line trapezoid indicated by left-oblique lines. Accordingly, the relationship of T1<T2 is obtained. That is, in the ‘print mode with 5 mm margin’, it is possible to improve the throughput by the difference between T1 and T2 in the invention.

As described above, according to the first embodiment, an optimum transport speed selecting unit 80b is provided. When any one of the modes ‘recording mode with no margin’, ‘3 mm margin mode’ and ‘5 mm margin mode’ is selected, the optimum transport speed selecting unit 80b sequentially compares the first distance from the recording medium sensor 14 disposed an upstream side of the nozzle orifice line 10b in the transport direction and the second distance, connected to a constant speed region where the transport roller 19 rotates at a speed level tentatively selected from a plurality of different speed level V3 (high speed), V2 (middle speed), V1, (low speed), where the recording paper P is transported during deceleration, from starting deceleration to stop, and selects the highest speed level in the plurality of speed levels V3, V2 and V1 of the transport roller 19 under the condition that the second distance is smaller than the first distance.

That is, when any one of the recording mode is selected, according to the selected mode, the highest speed level at which the recording paper P can be decelerated and stopped from the constant speed within a range not exceeding the first distance is selected. Then, the recording paper P is transported by the transport roller 19 that rotates at the selected highest speed level corresponding to one of the recording start positions P1 to P3 which are recording start positions. As a result, the time required to transport the recording paper P to one of the recording start positions P1 to P3, which are recording start positions, is reduced, which improves the throughput.

Further, in the recording head 13, the recording medium sensor 4 is disposed at an upstream side of the nozzle orifice line 10b in the transport direction. Accordingly, the second distance, connected to a region where the recording medium is transported at a constant speed, which is a distance during deceleration can be increased by increasing the first distance. As a result, as the first distance is increased, a speed level larger than the constant speed can be selected. In other words, an object transported at a low speed level can be significantly decreased and throughput can be improved.

After the recording medium sensor 14 detects the leading end of a recording paper P transported by the transport roller 19 rotating at a constant speed of the speed level selected by the optimum transport speed selecting unit 80b, the recording paper P is transported as much as the distance between the first and second distances at the constant speed, thereafter shifts into deceleration and stops. Because the recording paper P is still transported as much as the difference at the constant speed after the recording medium sensor 14 detects the leading end of the recording paper P, the apparatus is compact and can be freely designed with respect to the sensor arrangement and the paper can be stopped at the correct desired stop position.

The optimum transport speed selecting unit 80b compares the first and second distances in high speed level order of the plurality of different speed level V3 (high speed), V2 (middle speed), and V1 (low speed) (V3→V2→V1) and selects a speed level when the above condition is satisfied. Accordingly, when the distances are compared and selected in the order of low speed level or a predetermined order, a speed level satisfied with the condition can be quick and easily selected.

### Second Embodiment

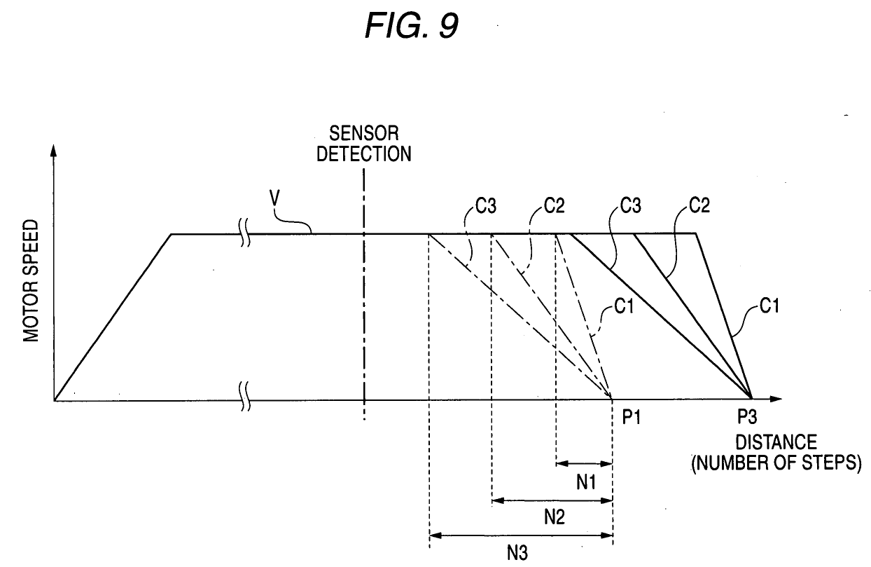

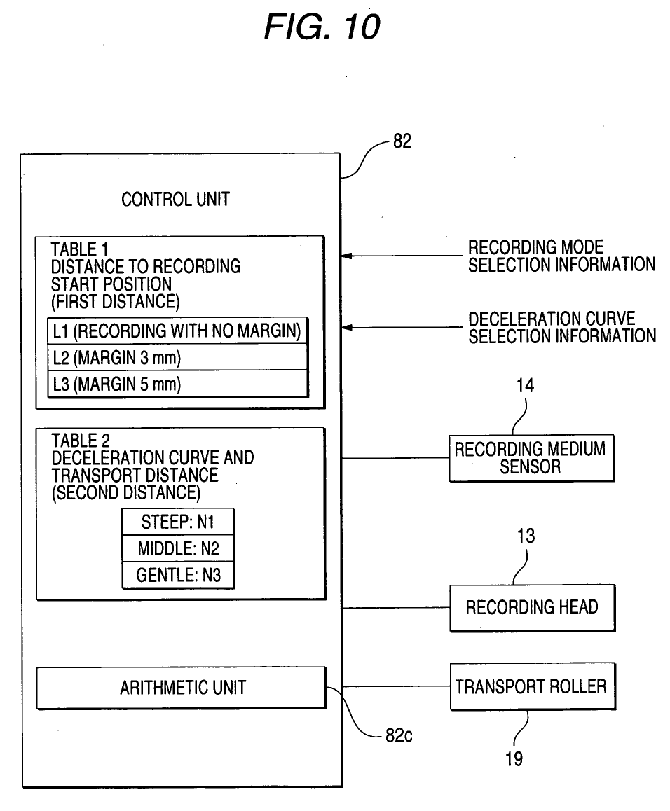

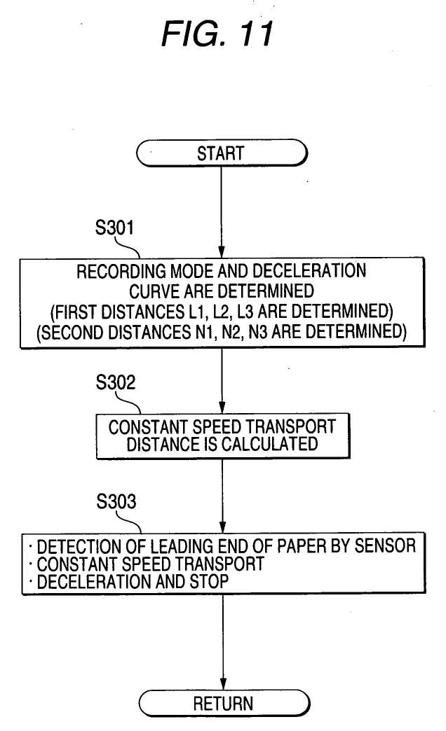

A second embodiment of the invention is described below with reference to FIGS. 9 to 11. FIG. 9 shows, in a recording apparatus of second embodiment, a graph illustrating the relationship of the transport speed and the distance of a recording paper to the recording start position (stop position) or a different deceleration curve (negative acceleration), FIG. 10 is a block diagram of the recording apparatus, and FIG. 11 shows a flow chart of a method of transporting a recording paper to the recording start position in the recording apparatus.

In the recording apparatus of second embodiment, a control unit 82, similar to first embodiment, has three recording modes of ‘recording mode with no margin’, ‘3 mm margin mode’, and ‘5 mm margin mode’ with respect to the leading margin of a recording paper P and the first distances (L1, L2, L3) in Table 1 that are information on the different recording start positions P1, P2, P3 in each of the modes.

The control unit 82 has information about a plurality of different deceleration curves (negative acceleration) in a deceleration region connected to a region of a constant speed V of the transport roller 19, which is a distance N1 of deceleration region corresponding to deceleration curve C1 having steep slope, a distance N2 of deceleration region corresponding to deceleration curve C2 having middle slope, and a distance N3 of deceleration region corresponding to deceleration curve C3 having gentle slope. Second distances, the information about the deceleration curves, are shown in Table 2.

The different deceleration curves in this embodiment are set as follows. The steep sloped deceleration curve C1 is set considering the recording speed, the gentle sloped curve C3 is set considering the accuracy of the recording position, and the middle sloped curve 32 is set considering the quality in the middle of the C1 and C3. When a user considers any one of them in recording, any one of the deceleration curves is selected.

The control unit 82 has an arithmetic unit 82c for calculating a constant speed transport distance. The arithmetic unit 82c calculates the distance transported at the constant speed V after the recording medium sensor 14 detects the leading end of a recording paper P that is transported by the transport roller 19 rotated at the constant speed V, the constant speed transport distance is obtained as the difference between the first and second distances.

Subsequently, the operation of the second embodiment is described. A user selects any one of the ‘recording mode with no margin’, ‘3 mm margin mode’, and ‘5 mm margin mode’ using a selecting unit (not shown), such as known selecting switch, and the selecting information of the recording mode is, as shown in FIG. 10, sent to the control unit 82. Further, any one of the deceleration curves C1, C2, and C3 is selected by a user and the information on the selection is sent to the control unit 82.

In the control unit 82, a first distances (L1, L2, L3) are determined and second distances (N1, N2, N3) are determined (S301). A constant speed transport distance is obtained by subtracting the second distances (N1, N2, N3) from the first distances (L1, L2, L3) (S302). After the recording medium sensor 14 detects the leading end of a recording paper P transported by the transport roller 19, the recording paper P is transported as much as the constant speed transport distance at the constant speed V (S303), thereafter decelerated on the basis of the selected deceleration curve and stopped at the recording start position (S303).

According to second embodiment, the control unit 82 has information on a plurality of different deceleration curves C1, C2, C3 in the deceleration region connected to a region where the transport roller 19 is rotated at the constant speed V, a plurality of recording margin about the leading end margin, and a first distances (L1, L2, L3) that are information of different recording start positions P1, P2, P3 with respect to each recording mode. Therefore, when the leading end of the recording paper P is stopped at each recording start positions P1, P2, P3 corresponding to the recording mode, other stopping method can be used by separately using the deceleration curves C1, C2, C3.

For example, when the improvement of throughput (recording speed) is considered, rapidly decelerated curve C1 is selected, as shown in FIG. 9, such that the region of the constant speed V before starting deceleration and furthermore the throughput can be easily improved. When recording quality is considered rather than the improvement of the throughput, gently decelerated curve C3 is selected, such that the accuracy of the stop position is improved and the leading end of the recording paper can be stopped at a desired stop position.

### Third Embodiment

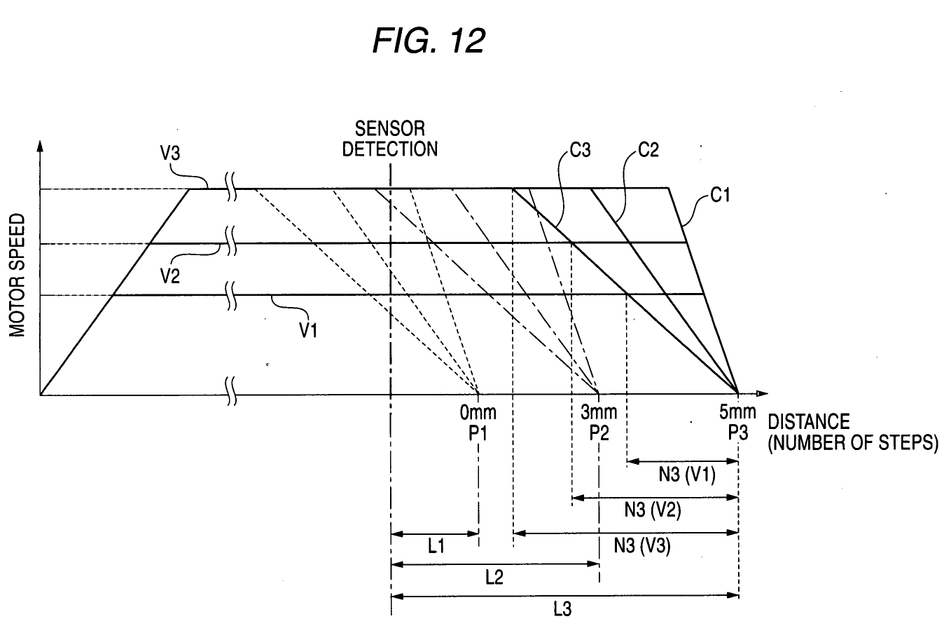

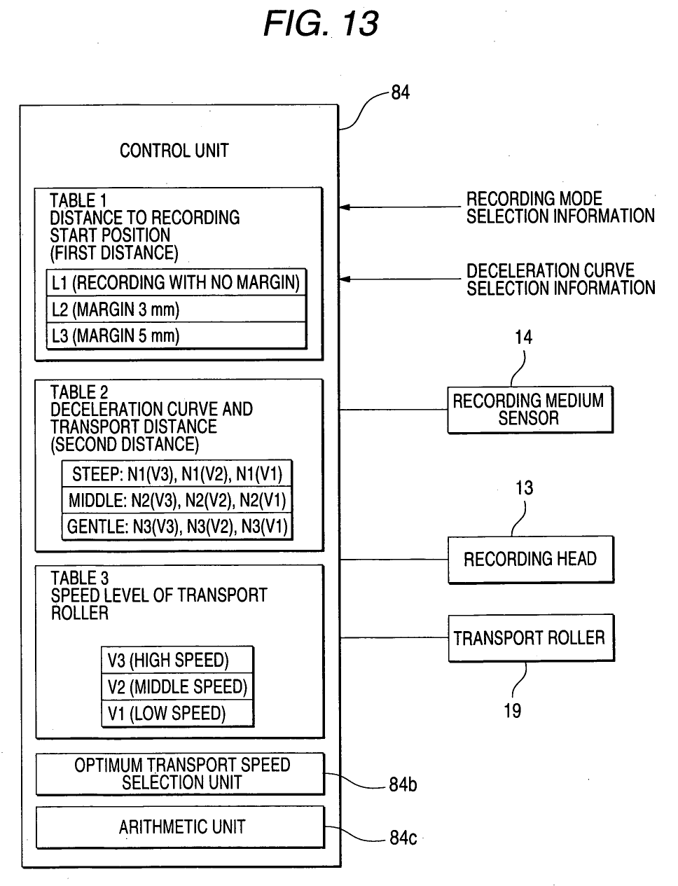

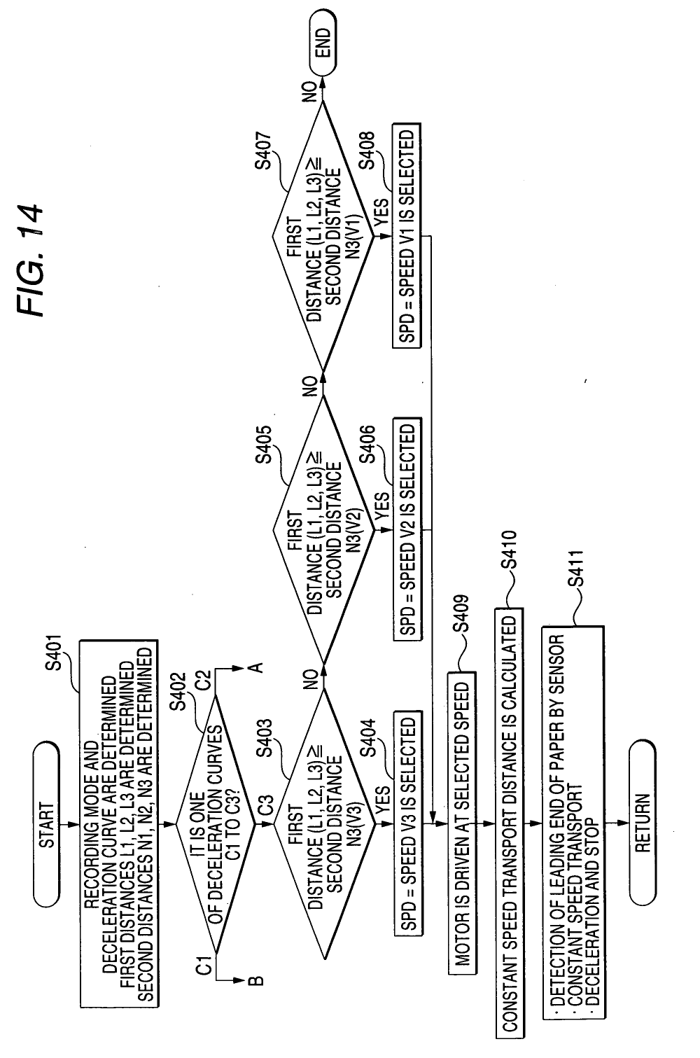

Third embodiment of a recording apparatus of the invention is described below with reference to FIGS. 12 to 16. FIG. 12 shows, in a recording apparatus of third embodiment, a graph illustrating the relationship of the transport speed and the distance of a recording paper to the recording start position (stop position) or a different deceleration curve, FIG. 13 is a block diagram of the recording apparatus, and FIGS. 14 to 16 show a flow chart of a method of transporting a recording paper to the recording start position in the recording apparatus.

In the recording apparatus of third embodiment, a control unit 84, similar to first and second embodiments, has three recording modes of ‘recording mode with no margin’, ‘3 mm margin mode’, and ‘5 mm margin mode’ with respect to the leading margin of a recording paper P and the first distances (L1, L2, and L3) in Table 1 that are information on the different recording start positions P1, P2, P3 in each of the modes.

Further, the control unit 84 has, similar to the first embodiment, the information on the three speed levels of the transport roller 19 (high speed V3, middle speed V2, low speed V1) in Table 3.

The control unit 84, similar to the second embodiment, has information on a plurality of deceleration curves C1, C2, C3, which are deceleration regions connected to a region of a constant speed of the transport roller 19.

With respect to each speed V3, V2, and V1 corresponding to the deceleration curves C1, C2, and C3 of the transport roller 19, the control unit 84 has, as the deceleration regions connected to the constant speed regions, distances of the deceleration region corresponding to the deceleration curve C1 having steep slopes N1(V3), N1(V2), and N1(V1), distances of the deceleration region corresponding to the deceleration curve C2 having middle slopes N2(V3), N2(V2), and N2(V1), and distances of the deceleration region corresponding to the deceleration curve C3 having gentle slopes N3(V3), N3(V2), and N3(V1).

As shown in FIG. 12, the dimensional relationship of the distances of the deceleration regions is as follows. For example, N3(V3)>N2(V3)>N1(V3) is concluded with respect to one speed level of the transport roller 19 and the other speed levels V2 and V1 are the same. As for one deceleration curve, for example, the deceleration curve C3, dimensional relationships of deceleration distances correspond to the three speed levels (V3, V2, and V1), that is, are satisfied as N3(V3)>N3(V2)>N3(V1). The other deceleration curves C2 and C1 are the same as the above, N2(V3)>N2(V2)>N2(V1) and N1(V3)>N1(V2)>N1(V1).

The control unit 84 has second distances N1(V3), N1(V2), N1(V1), N2(V3), N2(V2), N2(V1), N3(V3), N3(V2), and N3(V1) corresponding to the three speed level V3, V2, and V1 and deceleration curves C1, C2, and C3, in Table 2. Different deceleration curves, in the third embodiment, are the same as in the second embodiment. In other words, the deceleration curve C1 with steep slope is set corresponding to recording considering the recording speed, the deceleration curve C3 with gentle slope is set corresponding to recording considering the accuracy of the recording position, and the deceleration curve C2 with middle slope is set corresponding to recording considering the quality between the C1 and C3.

The control unit 84 has an optimum transport speed selecting unit 84b that, when a user selects any one of the recording modes and any one of the deceleration curves, compares the first distances L1, L2, L3 corresponding to the selected recording mode with the second distance corresponding to a speed level tentatively selected in a predetermined order with respect to the selected deceleration curve, and selects the highest speed level in the three speed levels V3, V2, V1 of the transport roller 19 when a condition that the second distance is smaller than the first distance is satisfied. In this embodiment, the optimum transport speed selecting unit 80b, in the high speed level order of the three speed levels V3, V2, V1, compares the second distance and the first distance, for example, in the order of N3(V3)→N3(V2)→N3(V1) and selects a speed level under the above-mentioned condition is satisfied.

The control unit 84 has an arithmetic unit 84c for calculating a constant speed transport distance. The arithmetic unit 84c calculates the distance transported at a constant speed after the recording medium sensor 14 detects the leading end of a recording paper P that is transported by the transport roller 19 rotated at the constant speed of the speed level selected by the optimum transport speed selecting unit 84b. The constant speed transport distance is obtained as the difference between the first and second distances.

Subsequently, the operation of the third embodiment is described. A user selects any one of the ‘recording mode with no margin’, ‘3 mm margin mode’, and ‘5 mm margin mode’ using a selecting unit (not shown), such as known selecting switch, and the selecting information about the recording mode is, as shown in FIG. 13, sent to the control unit 84. Further, any one of the deceleration curves C1, C2, and C3 is selected by a user and the information on the selection is sent to the control unit 84.

For example, when a user selects the ‘5 mm margin mode’, the stop position of the leading end of a recording paper P is P3. Accordingly, the first distance L3 is determined (S401). When a user selects the ‘deceleration curve C3 with gentle slope’, the selection is discriminated in step S402 and the operation moves to step S403. The optimum transport speed selecting unit 84b compares the first distance L3 and the second distance N3(V3) corresponding to the deceleration curve C3 with gentle slope. When the first distance L3 is larger than the second distance N3(V3) (S403), SPD=speed V3 and the speed level V3 (high speed) is selected (S404). When the first distance L3 and the second distance N3(V3) are the same (S403), the speed level V3 (high speed) is also selected (S404).

As shown in FIG. 12, the driving motor, i.e. the transport roller 19 is constantly accelerated up to the selected speed V3 (high speed), thereafter keeps the constant speed V3 (high speed) and transports a recording paper P at a constant transport speed V3′ (S409).

The arithmetic unit 84c calculates the constant transport distance L3-N3(V3) by subtracting the second distance N3(V3) from the first distance L3 while the transport roller 19 transports the recording paper P at the constant transport speed V3′ (S410). Further, the constant speed transport distance may be obtained before the transport roller 19 starts transporting the recording paper P at the constant transport speed V3′.

A detected signal when the recording medium sensor 14 detects the leading end of a transported recording paper P is sent to the control unit 84 (S411). The driving motor more rotates at the constant speed V3 (high speed) as much as the step corresponding to the constant speed transport distance (L3-N3(V3)) and keeps the constant speed transport (S411), thereafter changes into deceleration and starts decelerating, and stops to stop the leading end of the recording paper P at the stop position P3 (S411). Accordingly, considering the positional accuracy of recording, the recording can be performed at high throughput.

When a user selects the ‘3 mm margin mode’, i.e. ‘deceleration curve C3 with gentle slope’, the stop position of the leading end of a recording paper P is not P3 but P2. Accordingly, the first distance L2 is determined (S401). When the selection of the ‘deceleration curve C3 with gentle slope’ by a user is discriminated in step S402, then it moves to step S403. The optimum transport speed selecting unit 84b subsequently compares the first distance L2 and the second distance N3(V3) (S403). In the example shown in FIG. 12, the first distance L2 is smaller than the second distance N3(V3) and then it moves to step S405.

The optimum transport speed selecting unit 84b compares the first distance L2 and the second distance N3(V2) corresponding to the speed V2 (middle speed) slower than the speed V3 (high speed). When the optimum transport speed selecting unit 84b determines that the first distance L2 is larger than the second distance N3(V2) (S405), SPD=speed V2 and the speed level V2 (middle speed) is selected (S406). When the first distance L2 and the second distance N3(V2) are the same (S405), the speed level V2 (middle speed) is selected (S406).

The process of each step (S409 through S411) after the speed level V2 (middle speed) is selected is not changed as compared with the above process after the speed level V3 (high speed) is selected, so that the description will be omitted.

When a user selects the ‘recording mode with no margin’, that is, the ‘deceleration curve C3 with gentle slope’, the stop position of the leading end of a recording paper P is P1. Accordingly, the first distance L1 is determined (S401). Subsequently, the optimum transport speed selecting unit 84b compares the first distance L1 with the second distance N3(V3) in step S403 after step S402. As seen from FIG. 12, the optimum transport speed selecting unit 84b determines that the distance L1 is smaller than the second distance N3(V3) and it moves to step S405.

In step S405, the first distance L1 and the second distance N3(V3) are compared by the optimum transport speed selecting unit 84b. As seen from FIG. 12, the optimum transport speed selecting unit 84b determines that the first distance L1 is smaller than the second distance N3(V2) and it moves to step S407.

The optimum transport speed selecting unit 84b compares the first distance L1 with the second distance N3(V1) corresponding to the speed V1 (low speed) lower than the speed V2 (middle speed) (S407). When the optimum transport speed selecting unit 84b determines that the first distance L1 is larger than the second distance N3(V1) (S407), SPD=speed V1 and the speed level V1 (low speed) is selected (S408). When the first distance L1 and the second distance N3(V1) are the same (S407), the speed level V1 (middle speed) is also selected (S408).

The process of each step (S409 through S411) after the speed level V1 (low speed) is selected is not change as compared with the above process after the speed level V3 (high speed) is selected, so that the description will be omitted.

In the example shown in FIG. 12, the optimum transport speed selecting unit 84b determines that the first distance L1 is smaller than the second distance N3(V1) and a message informing that the recording is not available is displayed and the process stops. In order to be configured such that recording is not available, the Table should be set in advance such that a user cannot select.

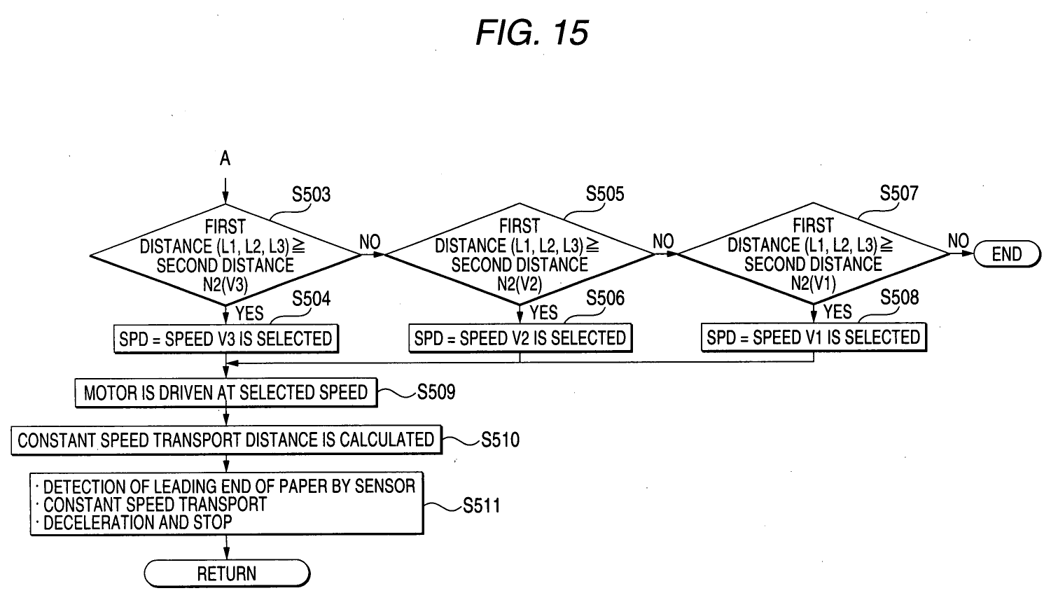

FIG. 15 is a flow chart shown a process when a user selects the deceleration curve C2 with middle slope. The basic process in each mode of ‘recording mode with no margin’, ‘3 mm margin mode’, and ‘5 mm margin mode’ is the same as the step described with reference to FIG. 14 except that the second distance changes from N3(V3), N3(V2), N3(V1) to N2(V3), N2(V2), N2(V1) and, such that the corresponding steps S503 through S511 will not be described.

In the example shown in FIG. 12, in both modes of the ‘5 mm margin mode’ and ‘3 mm margin mode’, SPD=V3 and the speed level V3 (high speed) is selected. In the ‘recording mode with no margin’, SPD=speed V1 and the speed V1 (low speed) is selected.

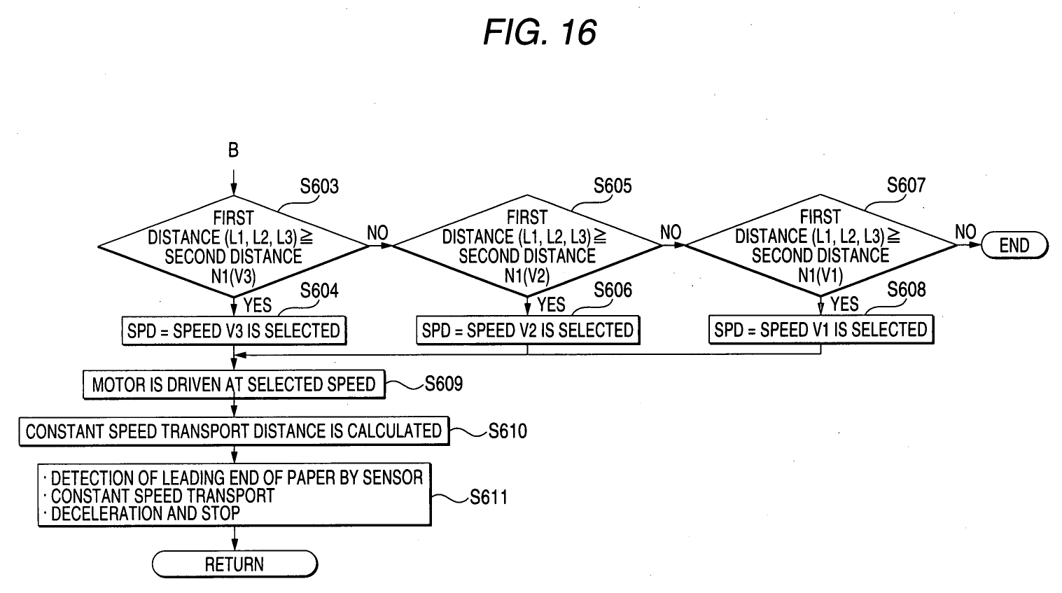

FIG. 16 is a flowchart showing the process when a user selects the deceleration curve C1 with steep slope. The basic process in each mode of ‘recording mode with no margin’, ‘3 mm margin mode’, and ‘5 mm margin mode’ is the same as the steps S403 through S411 in FIG. 14 except that the second distance changes from ‘N3(V3), N3(V2), N3(V1)’ to ‘N (V3), N1(V2), N1(V1), such that the corresponding steps S603 through S611 will not be described.

In the example shown in FIG. 12, in the modes ‘5 mm margin mode’, ‘3 mm margin mode’, and ‘recording mode with no margin’, SPD=speed V3 and the speed level V3 (high speed) is also selected.

Further, the invention is not limited to the above embodiments and it should be understood that a variety of modification and changes are included in the scope of the invention as claimed.

What is claimed is:

1. A recording apparatus comprising:
a recording head that has a nozzle orifice line, and performs recording on a recording medium;
a transport roller that transports the recording medium to a position opposite to the recording head; and
a control unit that controls recording operations including operations of the recording head and the transport roller, and has information about a plurality of speed levels different from each other which are rotational speeds for constant speed regions of the transport roller, a plurality of recording modes for leading end margins and information about recording start positions different from each other in each recording mode, and includes an optimum transport speed selecting unit that, when any one of the recording modes is selected, compares a first distance from a recording medium sensor that is disposed an upstream side of the nozzle orifice line in a transport direction to the recording start position corresponding to the selected recording mode with a second distance, where the recording medium is transported by a predetermined negative acceleration, from a deceleration start point which is connected to the constant speed region to a stop point, and selects the highest speed level in the plurality of speed levels of the transport roller when the second distance is smaller than the first distance, wherein
after a leading end of the recording medium transported by the transport roller rotating at a constant speed of the selected speed level is detected by the recording medium sensor, the recording medium is transported as much as difference between the first and second distances at the constant speed, then is decelerated by the predetermined negative acceleration and stopped.

2. A recording apparatus comprising:
a recording head that has a nozzle orifice line, and performs recording on a recording medium;
a transport roller that transports the recording medium to a position opposite to the recording head; and
a control unit that controls recording operations including operations of the recording head and the transport roller, and has information about a plurality of deceleration curves different from each other which are deceleration regions connected to constant speed regions of the transport roller, a plurality of recording modes for leading end margins and information about recording start positions different from each other in each recording mode, wherein
when any one of the recording modes and any one of the deceleration curves are selected, a first distance is defined as a distance from a recording medium sensor that is disposed an upstream side of the nozzle orifice line in a transport direction to the recording start position corresponding to the selected recording mode and a second distance is defined as a distance, where the recording medium is transported by the selected deceleration curve, from a deceleration start point to a stop point, and
after a leading end of the recording medium transported by the transport roller is detected by the recording medium sensor, the recording medium is transported as much as difference obtained by subtracting the second distance from the first distance at a constant speed, then is decelerated based on the deceleration curve and stopped at the recording start position.

3. The recording apparatus according to claim 2, wherein
the control unit has information about a plurality of speed levels different from each other which are rotational speed for constant speed regions of the transport roller, and includes an optimum transport speed selecting unit that selects the highest speed level in the plurality of speed levels of the transport roller when the second distance corresponding to each speed level is smaller than the first distance, and
after the leading end of the recording medium transported by the transport roller rotating at a constant speed of the selected speed level is detected by the recording medium sensor, the recording medium is transported as much as difference between the first and second distances at the constant speed, then is decelerated based on the deceleration curve and stopped.

4. The recording apparatus according to claim 3, wherein
the optimum transport speed selecting unit compares the second distance with the first distance in order of high speed in the plurality of speed levels.

5. The recording apparatus according to claim 3, wherein
the plurality of recording modes include a recording mode with no margin, a 3 mm margin mode and a 5 mm margin mode.

6. The recording apparatus according to claim 5, wherein
the plurality of speed levels of the transport roller include three patterns of high speed, middle speed and low speed.

7. The recording apparatus according to claim 5, wherein
the deceleration curves of the transport roller include three patterns of deceleration speed with steep slope, middle slope and gentle slope.

8. A method of transporting a recording medium that is transported by a transport roller to a recording start position opposite to a recording head having a nozzle orifice line and performing recording on the recording medium and that is stopped, the method comprising:
selecting any one of recording modes from a plurality of recording modes for leading end margins;
determining the recording start position corresponding to the selected recording mode,
selecting the highest speed level in speed levels at which a first distance from a recording medium sensor that is disposed an upstream side of the nozzle orifice line in a transport direction to the determined recording start position is larger than a second distance, where the recording medium is transported by a predetermined negative acceleration, from a deceleration start point which is connected to a constant speed region to a stop point; and
after a leading end of the recording medium transported by the transport roller rotating at a constant speed of the selected speed level is detected by the recording medium sensor, transporting the recording medium as much as difference between the first and second distances at the constant speed, then decelerating the recording medium by the predetermined negative acceleration and stopping the recording medium.

9. A liquid ejecting apparatus comprising:
a liquid ejecting head that has a nozzle orifice line, and performs liquid ejecting on an ejecting medium;
a transport roller that transports the ejecting medium to a position opposite to the liquid ejecting head; and
a control unit that controls liquid ejecting operations including operations of the liquid ejecting head and the transport roller, and has information about a plurality of speed levels different from each other which are rotational speeds for constant speed regions of the transport roller, a plurality of liquid ejecting modes for leading end margins and information about liquid ejecting start positions different from each other in each liquid ejecting mode, and includes an optimum transport speed selecting unit that, when any one of the liquid ejecting modes is selected, compares a first distance from an ejecting medium sensor that is disposed an upstream side of the nozzle orifice line in a transport direction to the liquid ejecting start position corresponding to the selected liquid ejecting mode with a second distance, where the ejecting medium is transported by a predetermined negative acceleration, from a deceleration start point which is connected to the constant speed region to a stop point, and selects the highest speed level in the plurality of speed levels of the transport roller when the second distance is smaller than the first distance, wherein
after a leading end of the ejecting medium transported by the transport roller rotating at a constant speed of the selected speed level is detected by the ejecting medium sensor, the ejecting medium is transported as much as difference between the first and second distances at the constant speed, then is decelerated by the predetermined negative acceleration and stopped.

10. A liquid ejecting apparatus comprising:
a liquid ejecting head that has a nozzle orifice line, and performs liquid ejecting on an ejecting medium;
a transport roller that transports the ejecting medium to a position opposite to the liquid ejecting head; and
a control unit that controls liquid ejecting operations including operations of the liquid ejecting head and the transport roller, and has information about a plurality of deceleration curves different from each other which are deceleration regions connected to constant speed regions of the transport roller, a plurality of liquid ejecting modes for leading end margins and information about liquid ejecting start positions different from each other in each liquid ejecting mode, wherein
when any one of the liquid ejecting modes and any one of the deceleration curves are selected, a first distance is defined as a distance from an ejecting medium sensor that is disposed an upstream side of the nozzle orifice line in a transport direction to the liquid ejecting start position corresponding to the selected liquid ejecting mode and a second distance is defined as a distance, where the ejecting medium is transported by the selected deceleration curve, from a deceleration start point to a stop point, and
after a leading end of the ejecting medium transported by the transport roller is detected by the ejecting medium sensor, the ejecting medium is transported as much as difference obtained by subtracting the second distance from the first distance at a constant speed, then is decelerated based on the deceleration curve and stopped at the liquid ejecting start position.

11. The liquid ejecting apparatus according to claim 1, wherein
the control unit has information about a plurality of speed levels different from each other which are rotational speed for constant speed regions of the transport roller, and includes an optimum transport speed selecting unit that selects the highest speed level in the plurality of speed levels of the transport roller when the second distance corresponding to each speed level is smaller than the first distance, and
after the leading end of the ejecting medium transported by the transport roller rotating at a constant speed of the selected speed level is detected by the ejecting medium sensor, the ejecting medium is transported as much as difference between the first and second distances at the constant speed, then is decelerated based on the deceleration curve and stopped.
